(19) United States
(12) Patent Application Publication
(10) Pub. No.: US 2004/0078222 A1
(43) Pub. Date: Apr. 22, 2004

(54) Method and system for providing medical health care services

(76) Inventors: Mansoor Khan, Northboro, MA (US); Ahmad Kasmieh, Hollis, NH (US)

Correspondence Address: IANDIORIO & TESKA, 260 BEAR HILL ROAD, WALTHAM, MA, 02451-1018, US

(21) Appl. No.: 10/384,511

(22) Filed: Mar. 7, 2003

Related U.S. Application Data
(60) Provisional application No. 60/363,015, filed on Mar. 8, 2002.
(60) Provisional application No. 60/443,305, filed on Jan. 29, 2003.

(51) Int. Cl. G06F 17/60

(52) U.S. Cl. 705/2

(57) ABSTRACT

A method is provided for ordering over a network one or more tests for a condition, the method including: recommending to the user over the network one or more tests based on the provisional diagnosis; providing to the user over the network an analysis of the one or more recommended tests if more than one test is recommended; allowing a user to select over the network one or more of the tests; determining whether a constraint exists on ordering any of the selected tests; ordering each of the selected tests over the network if no constraint exists to obtain each of the selected tests; and obtaining a result of each of the selected tests. Using the methods and systems described, a user, such as a physician, can easily obtain information over a network about a large number of tests and order any of the tests over the network. The server can also obtain payment and related information from the user at the time the one or more tests are ordered.

### RELATED APPLICATIONS

This application claims benefit of U.S. Provisional Application Serial No. 60/363,015, filed Mar. 8, 2002 entitled “Method for Diagnosing a Problem”, and claims benefit of U.S. Provisional Application Serial No. 60/443,305 filed on Jan. 29, 2003 entitled “A Method for Creating and Implementing Standards and Guidelines for Medical Diagnosis and Therapeutics”, both applications of which are herein incorporated by reference.

### FIELD OF THE INVENTION

This invention relates to a method and system for providing medical health care services and products, and more specifically, a method and system for ordering tests for medical health care services.

### BACKGROUND OF THE INVENTION

Recent changes in the medical health care industry have resulted in a substantial increase in the number of laboratory tests that are available today to a practicing physician. Examples of these tests include genomic sequencing, gene expression profiling, and tests that relate to bioterrorism and bioinformatics. As many as 9,000 tests may exist, but typical doctors may only be aware of a small percentage of these tests. To make matters even more difficult for physicians, new tests and new standards of care are being created at an explosive rate. Thus, there exists a need to present this vast amount of information about laboratory tests to doctors in an effective and reliable manner.

At the same time that the number of tests are increasing, healthcare institutions are experiencing cost constraints due to managed care reimbursement programs and thus would like to exercise caution while ordering laboratory tests, especially if the tests are outsourced to an external laboratory. Healthcare institutions would also like to ensure that they receive payment for the tests that are ordered. This is an important consideration since as much as eighty percent of the tests that insurance do not cover are never paid for by a patient. Thus, laboratorians, clinicians and medical compliance specialists would benefit in taking a proactive role in developing utilization guidelines and clinical standards when ordering tests.

### BRIEF SUMMARY OF THE INVENTION

It is therefore an object of this invention to provide a medical healthcare system that recommends one or more appropriate tests to a physician based upon a provisional diagnosis.

It is a further object of this invention to provide such a medical healthcare system that automatically orders each of the tests selected by a physician.

It is a further object of this invention to provide such a medical healthcare system that determines if any constraints exist on ordering any of the tests selected by a physician.

It is a further object of this invention to provide such a medical healthcare system that obtains payment from the user for tests that are ordered and are not covered by insurance.

The invention results from the realization that a more effective healthcare system can be obtained by recommending to a user over a network one or more tests based upon a provisional diagnosis, providing to the user an analysis of each of the tests if more than one test is recommended, allowing a user to select one or more of the tests, determining whether there is any constraint on each of the selected tests, ordering each of the selected tests if no constraint exists to obtain each of the selected tests, and obtaining a result of each of the selected tests.

The invention features a method for ordering over a network one or more tests for a condition. The method includes recommending to the user over the network one or more tests based on a provisional diagnosis of the condition; providing to the user over the network an analysis of the one or more recommended tests if more than one test is recommended; allowing a user to select over the network one or more of the tests; determining whether a constraint exists on ordering any of the selected tests; ordering each of the selected tests over the network if no constraint exists to obtain each of the selected tests; and obtaining a result of each of the selected tests.

In a preferred embodiment of the invention, the method may include obtaining payment for a test when the test is ordered if the test is not covered by insurance. The method may include providing one or more final diagnoses for the condition based on the result of each of the selected tests. The method may include allowing a user to identify at least one symptom of the condition. The method may include: recommending over the network at least one treatment based on the test results to cure the identified condition; identifying whether there is any constraint on ordering the recommended treatment; and ordering the treatment if no constraint exists for user to obtain the treatment. The method may include allowing the user to provide an override to order a test if a constraint exists on ordering the test. The method may include providing a notification of the override to one or more parties. The feature of determining whether there are any constraints on the one or more tests may include comparing an ICD 9 code for the provisional diagnosis with a CPT code for each of the selected tests to determine whether there is any constraint on each of the selected tests. The feature of providing to the user an analysis of the tests may include providing to the user a cost analysis of each of the tests if more than one test is recommended. The method may further include: collecting user feedback; and modifying the one or more recommended tests based upon the user feedback. The method may include: collecting user feedback; and modifying how to interpret the result of a selected test based upon the user feedback. The user may be a physician.

The invention also features a method for ordering tests over a network for a condition, the method including: recommending to the user over the network a plurality of tests based on a provisional diagnosis of the condition; allowing a user to select over the network two or more of the recommended tests; determining whether a constraint exists on ordering any of the selected tests; ordering each of the selected tests over the network if no constraint exists for the user to obtain each of the tests; routing over the network each of the selected tests to the corresponding supplier of each test; and obtaining a result of each of the selected tests.

In a preferred embodiment of the invention, the method may include providing one or more final diagnoses for the condition based on the result of each of the selected tests. The method may include obtaining payment for one of the tests if a constraint exists on ordering the test. The method may include allowing the user to provide an override to order one of the tests if one of the tests is not covered by insurance.

The invention also features a method for diagnosing over a network a condition and suggesting a treatment. The method including: allowing a user to identify over the network at least one symptom of a condition; hypothesizing a provisional diagnosis of the condition; recommending to the user over the network one or more tests based on the provisional diagnosis; providing to the user over the network an analysis of the tests if more than one test is recommended; allowing a user to select one of the tests; determining whether there are any constraints on the selected test; ordering the test over the network if no constraint exists for the user to obtain the selected test; obtaining a result of the selected test; identifying the problem based on the result of the selected test; recommending over the network at least one treatment based on the test result to cure the identified condition; identifying whether there are any constraints relating to the recommended treatment; and ordering the treatment if no constraints exist for the user to obtain the treatment.

In a preferred embodiment of the invention, the method may include providing a list of services or products from one or more suppliers relating to the recommended test. The method may include providing a list of services or products from one or more suppliers relating to the recommended treatment. The method may include repeating the above method if the condition is unable to be identified based on the result of the test.

The invention also features an article of manufacture, which includes: a computer readable medium having computer readable program code for ordering over a network one or more tests for a condition, the computer readable program code including instructions for: causing the computer system to obtain a provisional diagnosis of the condition; causing the computer system to recommend to the user over the network one or more tests based on the provisional diagnosis; causing the computer system to provide to the user over the network an analysis of the one or more recommended tests if more than one test is recommended; causing the computer system to allow a user to select over the network one or more of the tests; causing the computer system to determine whether a constraint exists on ordering any of the selected tests; causing the computer system to order each of the selected tests over the network if no constraint exists to obtain each of the selected tests; and causing the computer system to obtain a result of each of the selected tests.

In a preferred embodiment of the article of manufacture, the computer readable program code may include instructions for causing the computer system to obtain payment for a test if a constraint exists on ordering the test. The computer readable program code may include instructions for causing the computer system to provide one or more final diagnoses for the condition based on the result of each of the selected tests. The computer readable program code may include instructions for causing the computer system to allow a user to identify over the network at least one symptom of a condition. The computer readable program code may include instructions for causing the computer system to allow the user to provide over the network an override to order the test if a constraint exists on ordering the test. The computer readable program code may include instructions for causing the computer system to provide a notification of the override to one or more parties. The computer readable program code may include instructions for: causing the computer system to collect user feedback; and causing the computer system to modify the recommended tests based upon the user feedback.

The invention also features a server that includes a computer including a processor and computer readable program code executable on the processor for ordering over a network one or more tests for a condition, the computer readable program code configured to: recommend to the user over the network one or more tests based on a provisional diagnosis of the condition; provide to the user over the network an analysis of the one or more recommended tests if more than one test is recommended; allow a user to select over the network one or more of the tests; determine whether a constraint exists on ordering any of the selected tests; order over the network each of the selected tests if no constraint exists to obtain each of the selected tests; and obtain a result of each of the selected tests.

In a preferred embodiment of the server, the computer readable program code may be further configured to obtain payment for a test if a constraint exists on ordering the test. The computer readable program code may be further configured to provide one or more final diagnoses for the condition based on the result of each of the selected tests. The computer readable program code may be further configured to allow a user to identify at least one symptom of a condition. The computer readable program code may be further configured to allow the user to provide an override to order a test if a constraint exists on ordering the test. The computer readable program code may be further configured to provide a notification of the override to one or more parties. The computer readable program code may be further configured to: collect user feedback; and modify the recommended tests based upon the user feedback.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of a medical healthcare system in accordance with the present invention;

FIG. 2 is a more detailed schematic block diagram of the medical healthcare system of FIG. 1;

FIG. 3 is a flowchart of a method for ordering one or more tests for a condition using the medical healthcare system of FIG. 1;

FIG. 4 is a more detailed flowchart of the method of FIG. 3 for ordering one or more tests;

FIG. 5 is another embodiment of a method for ordering one or more tests that uses the medical healthcare system of FIG. 1;

FIG. 6 is yet another embodiment of the method of FIG. 3 in which user feedback is collected and used;

FIG. 7 is an exemplary software interface for a software program used on a server of the medical healthcare system of FIG. 1;

FIG. 8 is a software program interface that shows information about a specific test for the program of FIG. 7;

FIG. 9 is a software program interface that shows a shopping cart having two ordered tests for the program of FIG. 7;

FIG. 10 is a software program interface that shows the payment acceptance means for the program of FIG. 7;

FIG. 11 is an exemplary medical healthcare algorithm that is used with the software program of FIG. 7;

FIG. 12 is a software program interface that shows a patient profile used with the software program of FIG. 7;

FIG. 13 is a software program interface that shows patient clinical history for the software program of FIG. 7;

FIG. 14 is a software program interface that shows the patient medical history for the software program of FIG. 7;

FIG. 15 is a software program interface that shows a patient's anatomical pathology reports for the software program of FIG. 7;

FIG. 16 is a software program interface that shows a patient's clinical pathology reports for the software program of FIG. 7;

FIG. 17 is a software program interface that allows a user to order tests for the software program of FIG. 7; and

FIG. 18 is a schematic block diagram of a general embodiment of the subject invention.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

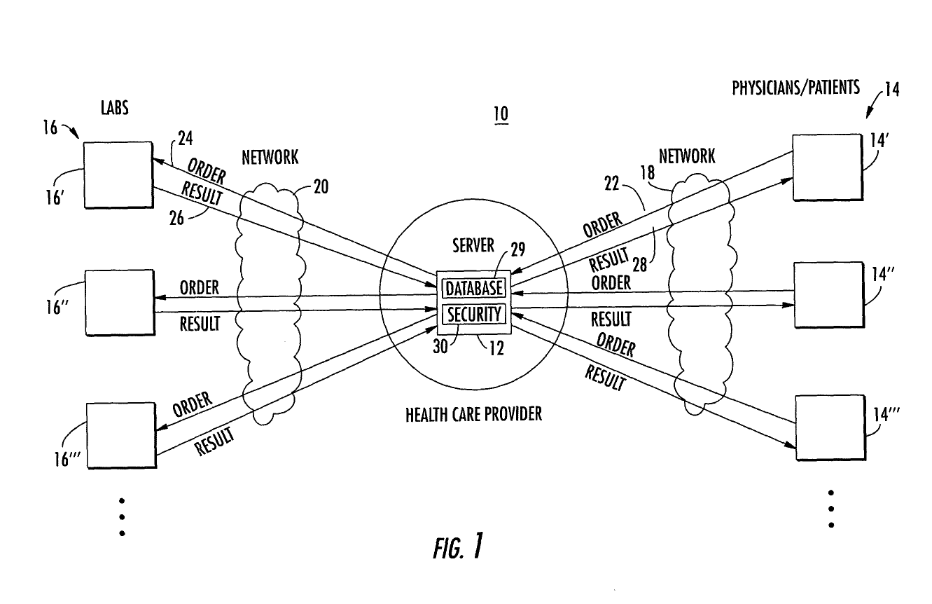

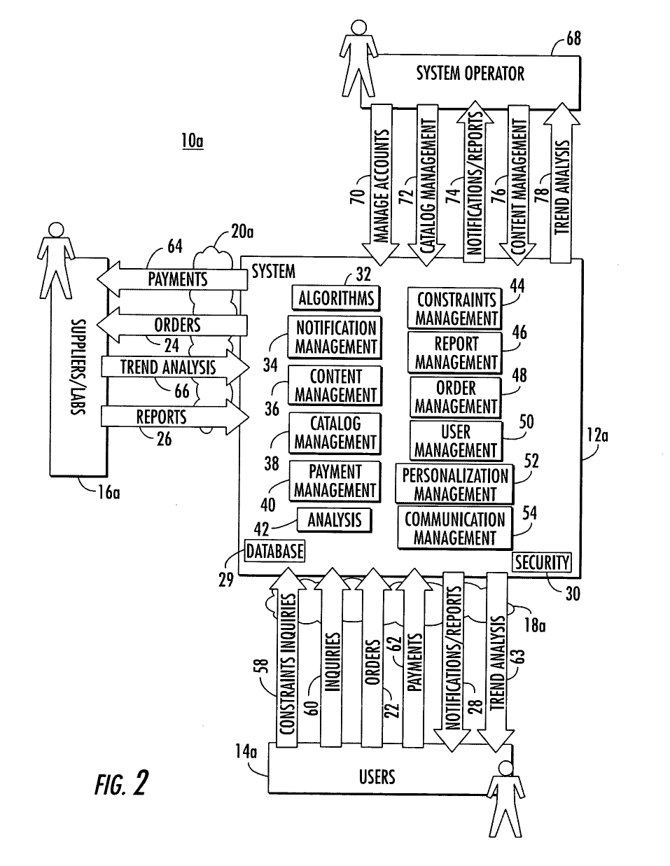

There is shown in FIG. 1 a medical healthcare system 10 which includes a server 12, one or more user terminals 14, one or more lab terminals 16, and networks 18 and 20. User terminals 14 can include one or more remote or local terminals 14′, 14″, and 14′″, . . . , each of which can be any apparatus that can connect to server 12 through network 18, such as a computer, computer terminal, cell phone, personal digital assistant (PDA), tablet PC, mobile phone, a programmable user interface, a programmable application interface (API) that achieves electronic data interchange, or any apparatus with a web browser. Lab terminals 16 can include one or more remote or local lab terminals 16′, 16″, 16′″, . . . , each of which can include any apparatus that can connect to the server through network 20, similar to user terminals 14. Server 12 is preferably located at a healthcare provider's location, such as a hospital, but alternatively can be located at a lab or other remote location or even split amongst different physical locations.

Typically, a user, such as a physician, obtains information or places an order for a test over terminal 14′ through line 22 which connects to server 12. If the physician places an order for a test, this information is transmitted over line 24 through network 20 to a lab with one of lab terminals 16. Once a lab has completed a test in accordance with the physician's instructions, the results of the test are transmitted over line 26, which can be the same line as line 24, to server 12. The information relating to the result of the test is transmitted back to the physician over line 28, which can be the same line as line 22. In this manner, a physician is able to obtain information about a patient, obtain information about a test and/or order a test from a lab. Lab terminal 16′ receives the test order from the physician and transmits the result of the test back to server 12 so that the physician can use the result of the test to help properly diagnose a patient's condition. Also, a physician at terminal 14′ can communicate with another physician at terminal 14″ to obtain information such as a second or an expert opinion. The communication lines 22, 24, 26, 28, etc. described herein can be either a wire or wireless communication line.

Server 12 typically includes or has access to one or more databases 29 which store information about each patient, the tests and test results relating to each patient, as well as information relating to each of the tests that a physician can order. Server 12 also includes one or more security programs 30 to ensure that physicians, patients, and labs only have access to the data for which they have been given appropriate authorization.

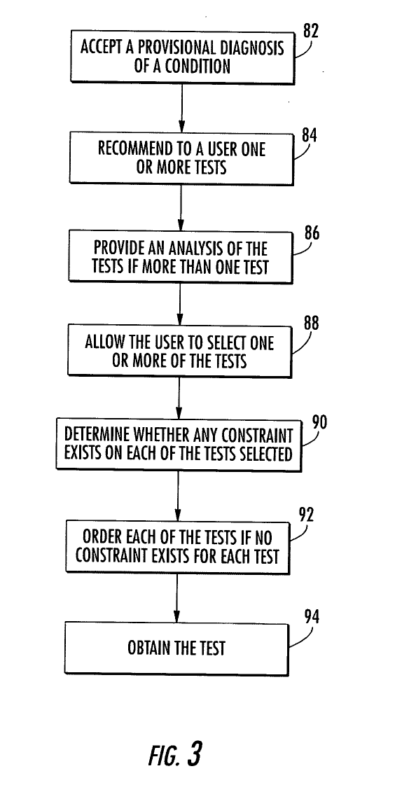

In a more specific embodiment, as shown in FIG. 2, where like parts have been given like numbers accompanied by a lower-case “a”, medical healthcare system 10a includes a server 12a that is accessed by users 14a, labs or suppliers 16a, or a system operator at terminal 68. Server 12a includes a number of software programs including an algorithms program 32, a notification management program 34, a content management program 36, a catalog management program 38, a payment management program 40, an analysis program 42, a constraints management program 44, a report management program 46, an order management program 48, a user management program 50, a personalization management program 52, and a communication management program 54. Although the programs on server 12a are described herein as being separate programs, it should be understood that any or all of these programs could be combined into any number of programs or could be used separately as described on server 12a.

Algorithms program 32 contains information that relates symptoms and/or diagnoses to specific tests. Using algorithms program 32, server 12a assists physicians in providing provisional and/or final diagnoses relating to a patient's symptoms and also provides a physician with recommended tests that correspond to a provisional, differential or a final diagnosis. Notification management program 34 provides to physicians or patients information relating to a provisional, differential or a final diagnosis or to specific tests. With notification management program 34, server 12a can provide alerts to users, such as physicians or patients, regarding, for example, new information, new tests that help test for a specific diagnosis, or new treatments relating to a specific diagnosis.

Content management program 36 maintains and provides information relating to each specific test. For example, information required for each test can include the information necessary to complete the test, the specimens to be collected for the test, how information and collected items are to be sent to a specific lab, and the estimated turnaround time for a specific test. Payment management program 40 controls the processes necessary to obtain payment for a specific test. A patient may accept responsibility for payment through executing an ABN and provide payment at a later time. A patient may alternatively provide payment through other methods including a credit card. For example, payment management program 40 can control how payment is accepted, when payment is accepted, whether or not any credit limit exists for a particular test, and any other processes necessary to obtain and track payment for any test.

Analysis program 42 is used to provide analyses of tests and to analyze trends that relate to prior tests that were ordered by physicians. Analysis program 42 also provides the user with an analysis, such as a cost, cost/benefit, or turn-around time analysis of each test if the server recommends more than one test to the user. Analysis program 42 can also use data mining to obtain the information relating to trends. For example, analysis program 42 can compare the actual turn-around times with estimated turn-around time to modify the estimated turn-around time if necessary. Analysis program 42 can be used to analyze the efficacy of the test as it relates to the condition. Analysis program 42 can also compare test results that it obtains with test results of the general population to ensure that the test results obtained from a specific lab are within reasonable limits. For example, if cholesterol tests from a specific lab show cholesterol levels that are far higher than in the cholesterol tests of the general population, analysis program 42 could determine that the cholesterol tests obtained from the specific lab are potentially inaccurate.

Constraints management program 44 includes guidelines as to whether or not a physician can order a test for a particular patient or in general. Constraints management program 44 not only provides information about what tests cannot be ordered but also about what tests may be preferable to order. For example, constraints management program 44 may recommend that a physician order a new test that was not recommended previously. The guidelines used by constraints management program 44 can be derived from medical programs such as Medicare, can be derived from insurance programs that dictate which tests can or cannot be ordered for specific patients or healthcare programs, or by the user or healthcare institution, possibly using data derived from analysis program 42. Constraints management program 44 also determines if a patient has previously taken a specific test and therefore does not need to have the test completed again.

Report management program 46 generates reports that include information about specific patients and determines who can view these reports. For example, report management program 46 may determine that one physician or healthcare provider has authorization to review a specific report but that another healthcare provider does not. Order management program 48 maintains and provides information that needs to go to one or more groups or systems, such as labs, clinical systems or financial systems, which can include the ability to route necessary information to the one or more groups or systems. Order management program 48 can route information based upon considerations such as a lab's ability to do a test, turn-around time or cost.

User management program 50 is a roles-driven user management program. User management program 50 defines roles for each user of healthcare management system 10a and assigns privileges to each of the roles. A user, such as a patient, may not have any privileges to access server 12a, but may still be assigned a role by user management program 12a. The roles assigned to each user assist security program 30 in determining if a specific user can access specific information on server 12a.

Personalization management program 52 presents each user that accesses the server 12a with a personalized user interface. Personalization management program 52 can personalize each user's personalized interface on the fly such that a user has the most up-to-date information available to the user. Personalization management program 52 can provide, for example, data relating to the effectiveness of specific tests that the user has taken, ordered, or may order in the future.

Communication management program 54 allows communications between various users of the medical health care system 10a. For example, communication management program 54 can allow the communication between two physicians who wish to communicate about a specific patient. Also, the communication management program can allow communication between a physician and a lab regarding a specific test.

As described above, each of users 14a orders a test over line 22 and receives test results, a notification or a report on line 28. Additionally, users 14a can make an inquiry with regard to whether there are any constraints with respect to a particular test on line 58. Each of the users 14a can also make a general inquiry with regard to one of the patients or a specific test on line 60. Payment for a test is transmitted from the user to a laboratory over line 62.

Also as noted above, each of the labs 16a can receive an order on line 24 and transmit test results or a report over line 26. Additionally, each of the labs 16a receives payment for a test or other service or product on line 64 and provides trend analyses on line 66. It should be noted that each of the communication lines between labs 16a and server 12a, as well as the communication lines between users 14a and server 12a, can either be communicated over a single data line or several data lines as shown.

At terminal 68, a system operator, such as a server administrator or information technology personnel, manages the information and programs on server 12a. The system operator manages accounts on line 70, updates or manages catalogs and catalog management on line 72, and manages the content in the content management program on line 76. The system operator receives notifications or reports on line 74 and receives trend analyses on line 78. It should be noted that all the data lines between the server 12a and system operator terminal 68 can be either individual communication lines or can be a single communication line.

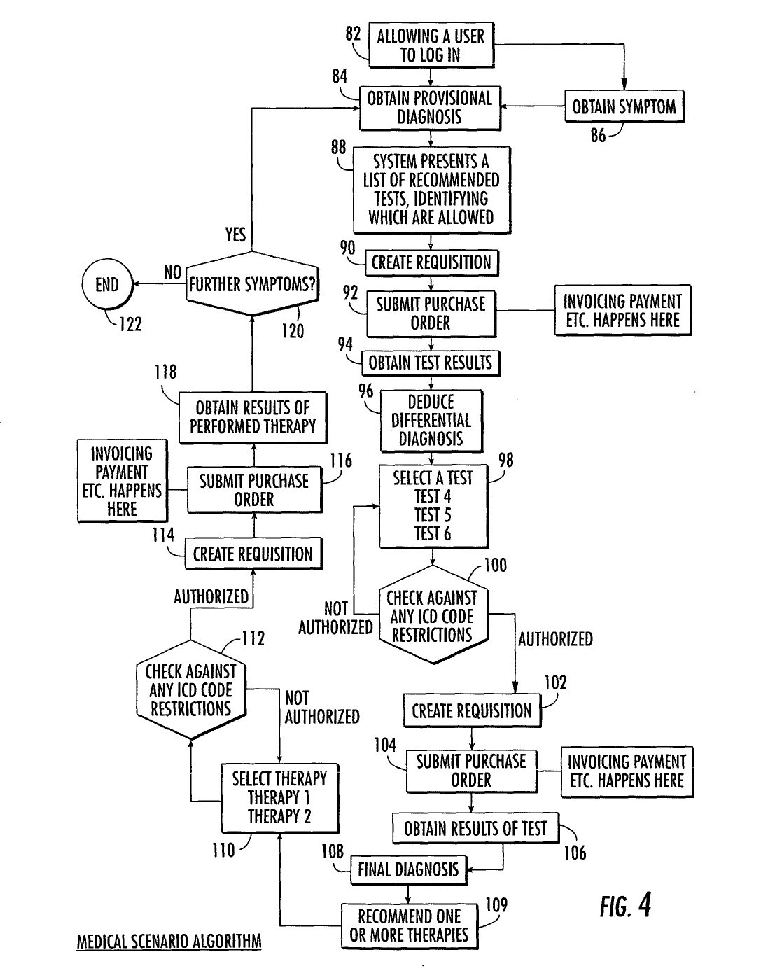

The flowchart of FIG. 3 describes ordering one or more tests and begins at step 82 with accepting a provisional diagnosis of a condition. At step 82, a user inputs into the medical healthcare server 12, FIG. 1, a provisional diagnosis from a terminal 14′. Alternatively, a user communicates to the server one or more symptoms relating to a condition and the server will provide the provisional diagnosis. In step 84, FIG. 3, the server recommends to the user one or more tests relating to the provisional diagnosis of the condition. In step 86, the server provides an analysis to the user of the tests if more than one test is recommended. The analysis provided to the user can be, for example, a cost, cost/benefit or a user feedback analysis of one or more of the tests. With this information, a user, such as a physician, can make an informed choice as to which tests, if any, to order for a specific patient. In step 88, the user is allowed to select one or more of the tests.

In step 90, the constraints management program 44, FIG. 2, determines whether any constraint exists on each of the tests selected. As noted above a constraint can exist with regard to a healthcare program, a Medicare program or a user may have already ordered or taken one of the selected tests. In step 92, FIG. 3, the server orders each of the tests if no constraint exists for each particular test. If a constraint does exist for a particular test, the server can additionally ask the user whether the user desires to pay for the test himself. For example, the server or the healthcare provider can ask a patient to fill out an advanced beneficiary notice (ABN) which states that the patient will pay for any test that is not covered by insurance and/or that the patient recognizes that insurance will not pay for the test. In step 94, the server obtains the selected tests that were ordered. The information obtained from the selected tests can be incorporated into a corresponding patient profile data file that relates to each patient.

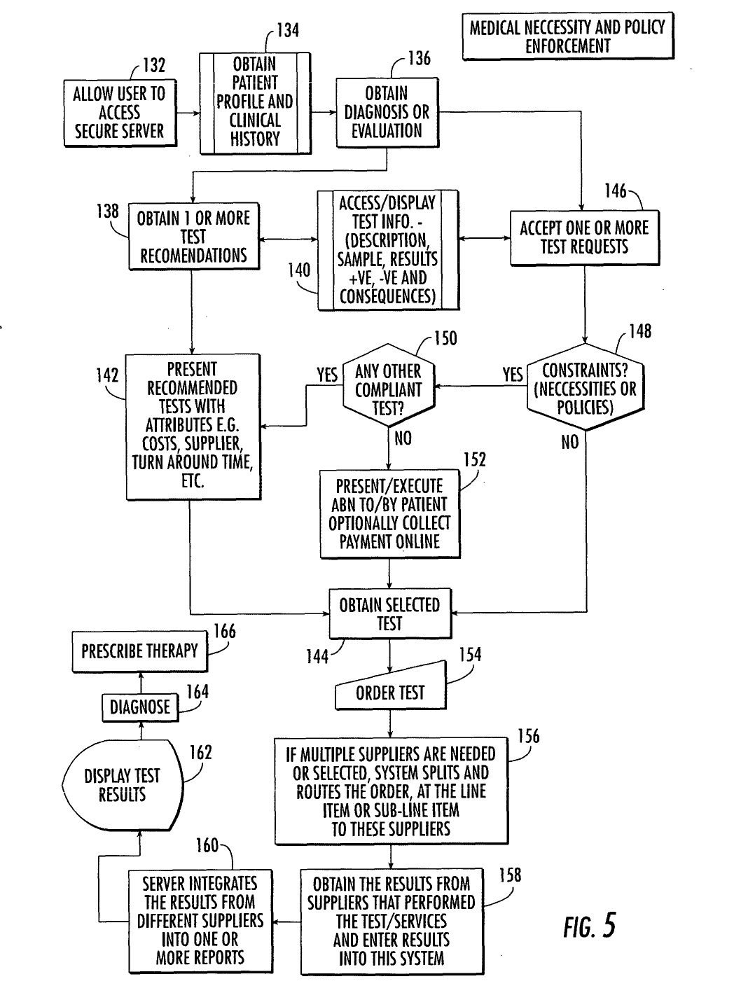

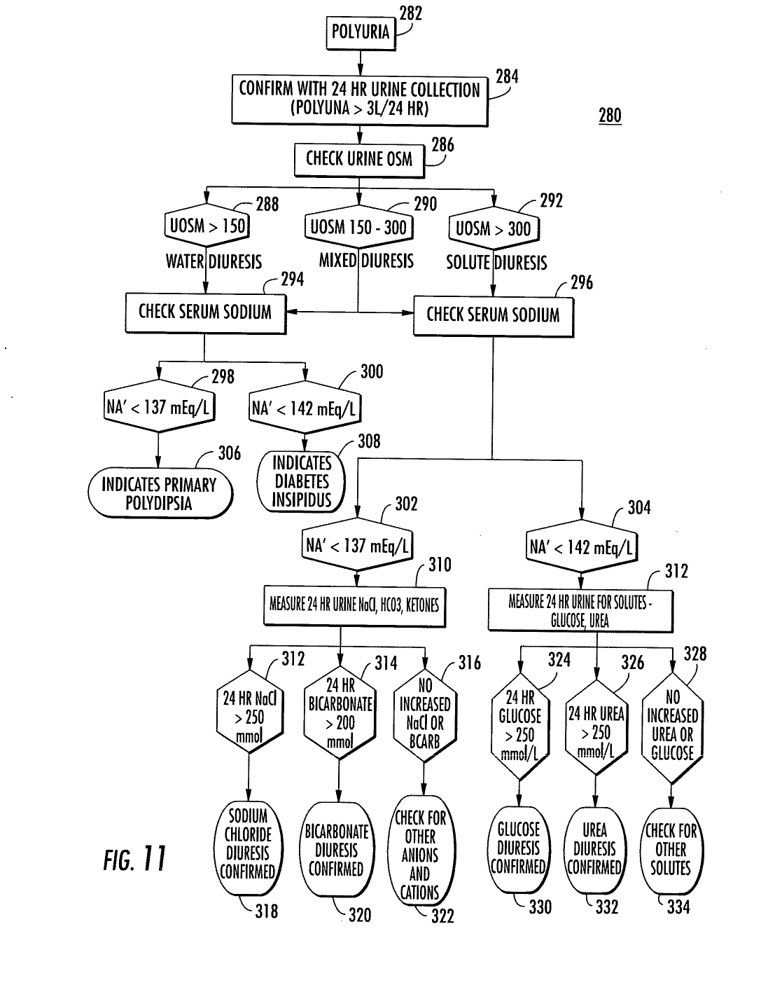

The flowchart of FIG. 4 describes ordering one or more tests and begins at step 82, with allowing a user to log into medical healthcare server 12, FIG. 1. The user may also obtain a patient profile and clinical history from a server database at step 82. In step 84, FIG. 4, the server obtains a provisional diagnosis of a condition. A user, such as a physician, provides the provisional diagnosis to the server or alternatively the server determines the provisional diagnosis after the user inputs, in step 86, one or more symptoms of the condition into the server. In step 88, the server presents a list of recommended tests to the user. An algorithm, such as the one shown in FIG. 11, can be used to determine one or more appropriate tests to recommend to a user. Alternatively, a look-up table could provide recommended tests for a condition or symptom. At this time, the server can identify which tests are allowed and do not have a constraint or the server can identify which tests have a constraint after the user has selected the tests. In step 90, the server creates a requisition for each selected test. In step 92, the server submits a purchase order to the appropriate labs at which the test will be performed. Obtaining payment from the user if necessary also occurs in step 92.

In step 94, the server obtains the results of each of the tests that were performed. In step 96, the server determines a differential diagnosis based upon the test results obtained in step 94. In step 98, the user, such as a physician, can select one or more tests in conjunction with the diagnosis determined in step 96. In step 100, the server determines whether there are any constraints against obtaining one of the tests selected in step 98. For example, the server can compare an ICD code associated with the diagnosis with the CPT code that is associated with each selected test to determine whether there is any constraint on any of the selected tests. Other codes, look-up tables or other information could be used to determine if any constraints exist. If there is a constraint at step 100 against the user ordering one of the selected tests, the user can be allowed the option to select one or more alternative tests in step 98. If there are no constraints against the one or more selected tests selected in step 98, the server creates a requisition for the one or more tests in step 102 and submits a purchase order to the appropriate labs in step 104. Obtaining payment from a user if necessary also occurs in step 104.

Once the selected tests have been completed by the appropriate labs, in step 106 the server obtains the results of the tests. The server uses the results of the test to create a final diagnosis in step 108. In step 109, the server can recommend to a user one or more therapies that correspond to the final diagnosis determined in step 108. In step 110, the user selects one or more of the therapies. In step 112, the server checks to see if there are any constraints that would restrict the user from obtaining the one or more selected therapies. For example, the server can check the ICD code associated with the final diagnosis to determine if the user can obtain each selected therapy. If the user is not authorized to obtain a specific therapy, the server allows the user to reselect one or more therapies related to the final diagnosis in step 110. The server can allow the user to provide an override to order the one or more therapies. If each of the selected therapies does not have any constraints against obtaining the therapy, the server creates a requisition for the selected therapy in step 114. In step 116, the server will submit a purchase order to one or more service providers or product suppliers for the recommended therapy. Obtaining payment from the user if necessary occurs in step 116.

In step 118, the server obtains the results of the performed therapy, which may have been performed by either a physician or the patient. In step 120, the server determines whether or not there are any further symptoms of the condition. Steps 118 and 120 can be combined into one step. If no further symptoms exist of the condition, then the server ends its routine in step 122. If further symptoms do exist of the condition, the server can go back to step 84 to determine a provisional diagnosis of the condition.

The flowchart of FIG. 5 describes obtaining one or more tests from a plurality of labs and begins at step 132 with allowing a user to access secure server 12, FIG. 1, from a terminal 14′. In step 134, FIG. 5, the server obtains a patient profile and corresponding clinical history from the server database. In step 136, the server obtains a diagnosis from the user or determines a diagnosis based upon one or more symptoms provided by the user. In step 138, the server provides one or more test recommendations based upon the diagnosis. In step 140, the server accesses and displays to the user corresponding test information, which can include the test description, a specimen of the test, sample test results, the meaning of positive and negative test results and any consequences of the results of the test. In step 142, the server presents the recommended tests to the user with the corresponding information relating to the test, which can include the information accessed in step 140 and other information such as the costs, supplier and the turn-around time of each of the one or more recommended tests. If the server recommends more than one test, the server provides to the user at step 142 an analysis of the one or more tests. In step 144, the server obtains from the user the one or more tests selected by the user and the selected supplier of a test if a test can be ordered from more than one supplier.

Alternatively, rather than using the method starting at step 138 and proceeding to step 144 in which the server recommends one or more tests, the server can accept one or more test requests from the user in step 146. The server accesses the corresponding test information in step 140. The server then determines whether or not the one or more tests have any constraints against them in step 148. If there are no constraints against ordering the tests, the server obtains the selected tests in step 144. If there are constraints against ordering the one or more tests selected in step 146, the server determines in step 150 if there are any other tests that do not have constraints against the user obtaining them. If there is an alternate test without constraints, the server presents the recommended test to the user in step 142. If there is no test that does not have a constraint, in step 152 the server verifies that the patient has executed an advanced beneficiary notice (ABN), which gives a recognition that insurance will not pay for the test, or that the patient has otherwise provided payment for the one or more noncompliant tests on-line. Once the server has verified the user has provided payment or has accepted responsibility for payment, the server obtains the selected tests in step 144.

In step 154, the server orders the one or more tests. If one or more suppliers or labs are required to obtain the one or more tests, in step 156 the server splits and routes the orders to the appropriate suppliers or labs. In step 158, the server obtains the test results from the one or more suppliers or labs that performed the tests and enters the test results into the server database. In step 160, the server integrates the results from the different suppliers into the one or more corresponding reports, which can be patient profiles. In step 162, the server displays the test results to a user. In step 164, the server provides a diagnosis to the user and in step 166 the server or physician prescribes a therapy based upon the diagnosis provided in step 164.

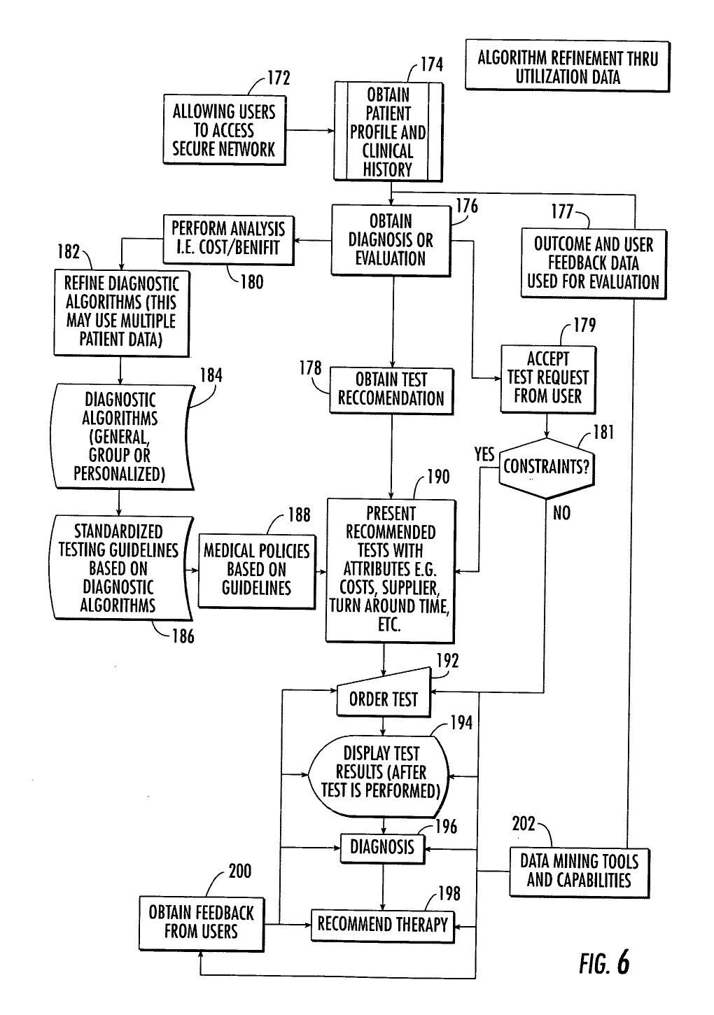

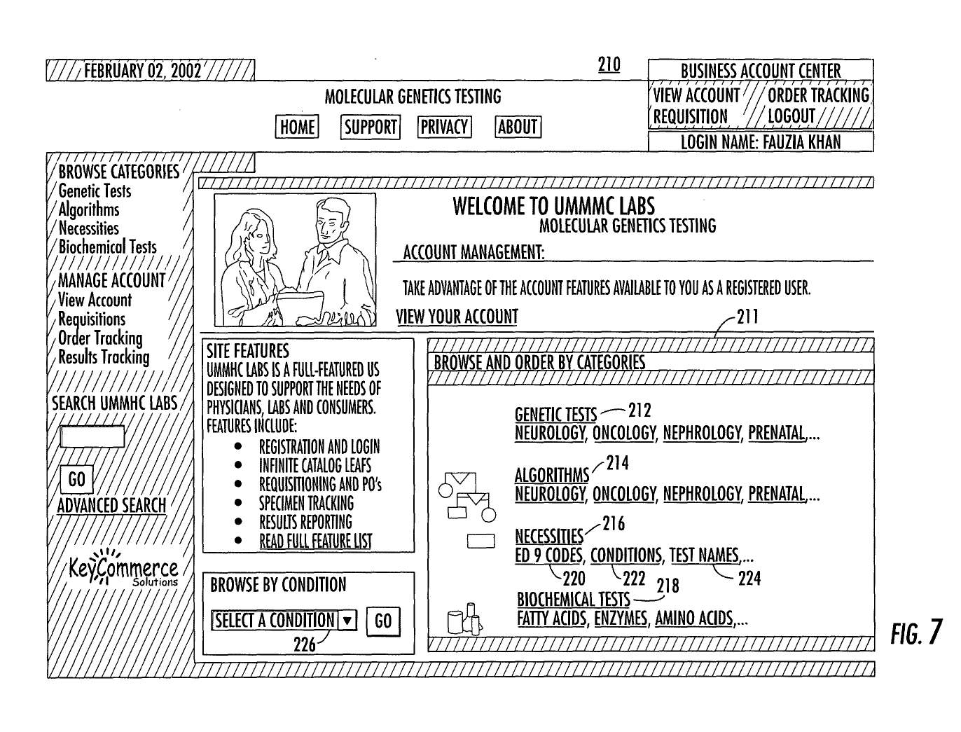

The flowchart of FIG. 6 describes a method that includes using user feedback and begins at step 172 with allowing users to access secure network 12, FIG. 1, through terminal 14′. In step 174, FIG. 6, the user can obtain a patient profile and clinical history, which describes tests that the patient has already taken and tests that may currently be on order. In step 180, the server obtains a diagnosis, which can be obtained either from the user or from an algorithm provided by the server. In step 178, the server determines which one or more tests to recommend to the user based upon the obtained diagnosis at step 176. In step 178, the server performs an analysis, such as a cost or cost/benefit analysis, of the one or more tests. In step 182, diagnostic algorithms that determine which one or more tests to recommend can be refined based upon outcome and user feedback data obtained in step 177. This feedback data may use data from multiple patients. In step 184, the server determines whether or not to revise the diagnostic algorithms for just the one person or for a group of people. In step 186, the server determines whether or not to change the standardized testing guidelines based upon the revised diagnostic algorithms in step 184. In step 188, medical policies can be revised based upon the revisions made to the testing guidelines in step 186. Steps 182-188 can be performed by the server or by the user using programs located on the server. In step 190, the user is provided with the one or more recommended tests with an analysis that includes one or more attributes of each test such as the cost of the test, the test supplier, and the estimated turn-around time of the test. The tests recommended at step 190 can be based upon the data obtained at steps 182-188.

Alternatively, rather than having the server recommend one or more tests to the user, the server can accept a test request from the user in step 179. In step 181, the server determines whether or not the one or more requested tests have any constraints against them. If there are no constraints against ordering the requested tests, the server orders the tests in step 192. If there are constraints against ordering the requested tests, in step 190 the server automatically recommends one or more alternative tests to the user, but can provide the user with the option to override the system to order the one or more tests with constraints.

In step 192, the server orders the one or more tests that were selected by the user either in step 190 or step 179. Once the server obtains the test results, in step 194 the test results are displayed to the user. In step 196, the server provides to the user a diagnosis of the condition based upon the test results. In step 198, the server recommends therapy for the diagnosed condition.

In step 200, the server obtains feedback from users regarding the effectiveness or desirability of the therapy, the diagnosis or the one or more tests that they selected. The feedback obtained from the users in step 200 can be used to modify the processes of ordering a test in step 192, displaying the test results in step 194, providing a diagnosis in step 196, and recommending a therapy in step 198. Alternatively or additionally, data mining tools used in step 202 can be used to analyze the user feedback as well as the outcome data from steps 194, 196 and/or 198, which can be used for the creation, modification and the evaluation of the tests and diagnostic algorithms, standardized testing guidelines, and medical policies based upon the guidelines in steps 182, 184, 186 and 188 as described above.

A software program interface 210, FIG. 7, includes a category list 211 having a number of links to categories that the user can click on and select to view. For example, category list 211 includes a genetic tests link 212, an algorithms link 214, a necessities link 216, and a biochemical tests link 218. Each of the category links can be further broken down into subcategory links. For example, genetic tests link 212 can include links to the different types of genetic tests, algorithms link 214 can include links to the different specific types of algorithms, necessities link 216 can include a codes link 220, a conditions link 222 and a test names link 224. Biochemical tests link 218 can include subcategory links of specific types of biochemical tests. A link to anatomical pathology tests can also be provided. A user can also browse by condition by selecting button 226 and scrolling to a particular condition to view information associated with that condition.

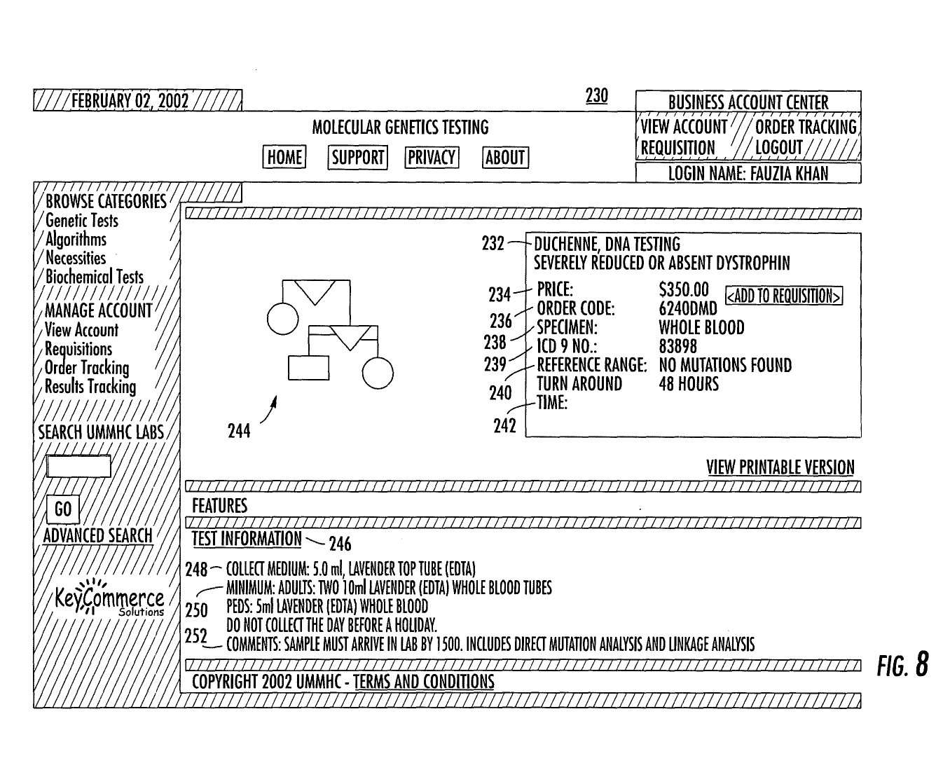

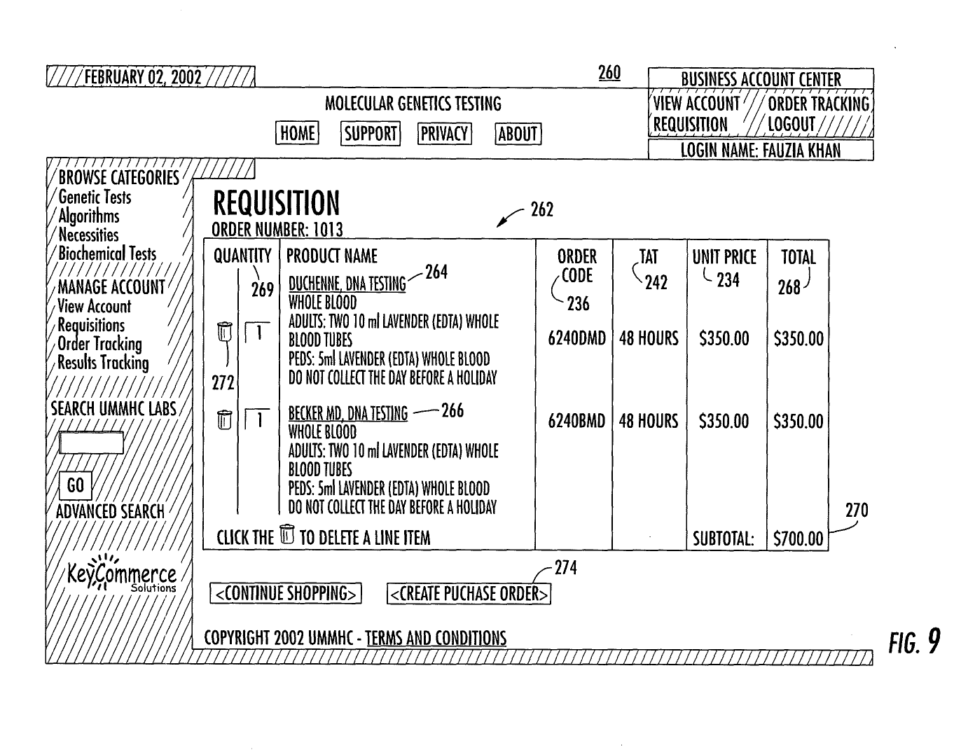

If a user selects a particular test on interface 210, software interface 230, FIG. 8, is displayed to the user. Software interface 230 includes information about a test 232, such as Duchenne, DNA testing. The information shown about the test can include its price 234, the order code 236, the specimen required to obtain the test 238, one or more ICD codes 239 relating to one or more diagnoses, the reference range of the test 240 and the estimated turn-around time 242 of the test. Additionally, interface 230 includes a sample algorithm 244 associated with the tests that can be clicked on to show a larger view of the algorithm. Further test information 246 is also shown which includes the necessary collection medium 248 in which the test sample is to be collected, the minimum amount 250 of test sample to be collected, and any other comments 252 that are relevant to the administration or ordering of the tests.

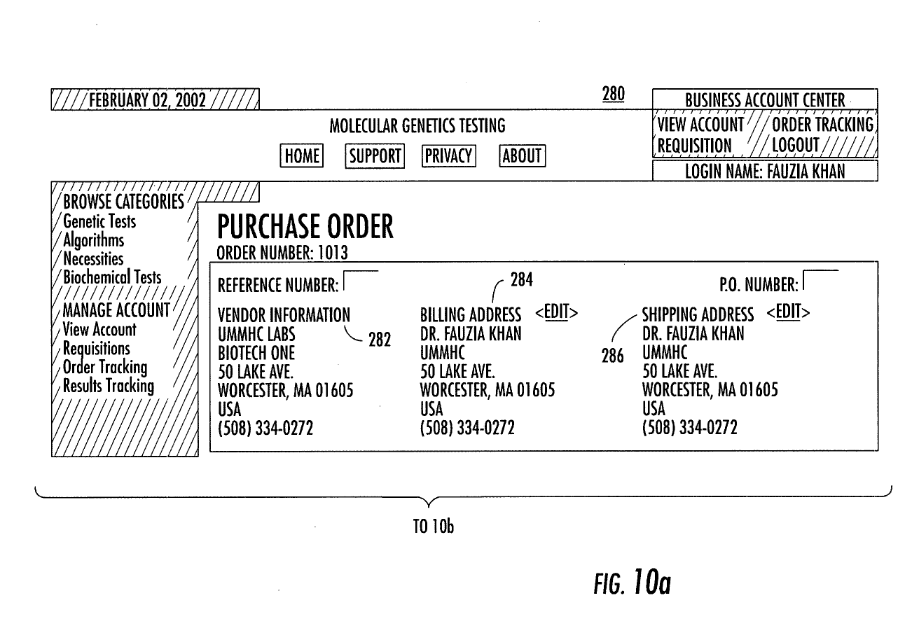

A requisition software interface 260, FIG. 9, includes a shopping cart 262 that displays the one or more ordered tests 264, 266. For each test, shopping cart 262 includes the test's order code 236, the turn-around time 242, the unit price 234 of the test and the total cost 268 which will depend on the quantity 269 of tests ordered by the user. The user can click on a symbol 272 of a trashcan to delete one of the tests from the requisition. A subtotal price 270 is displayed for the total cost of all the tests 264, 266 that are ordered. A user creates a purchase order for the test by clicking on button 274.

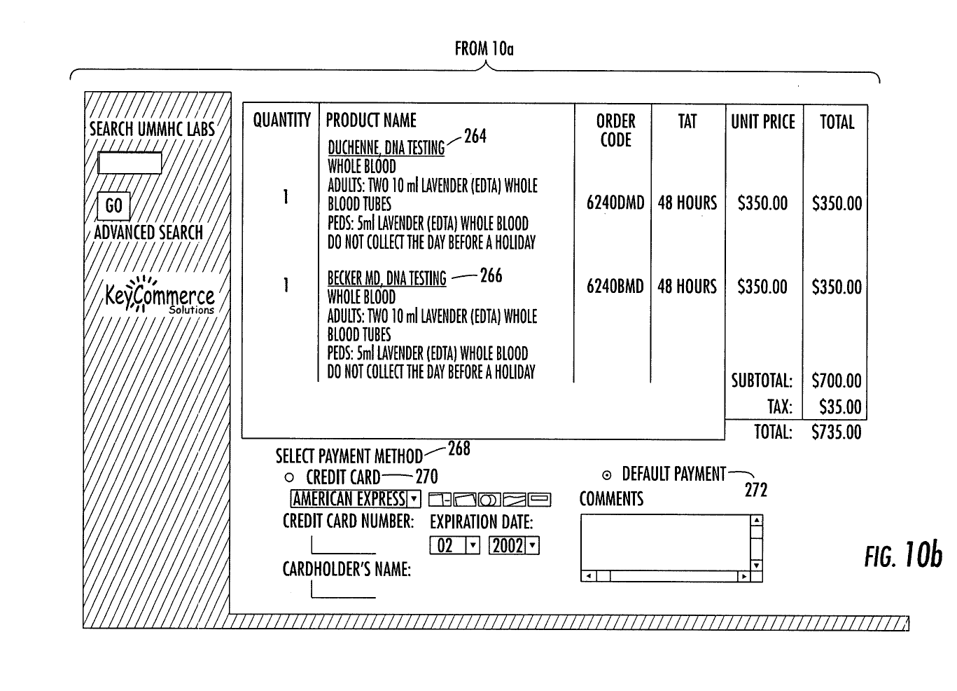

A purchase order software interface 280, FIG. 10, can include vendor information 282 describing the lab or supplier of the test, the billing address 284 of the user, the shipping address 286 of the user, and information about the one or more tests 264, 266 to be purchased. Payment for tests 264, 266 is determined in section 268 of interface 280, in which the user selects button 270 for a credit card or button 272 to select or a default form of payment that the user or server has previously specified. The default form of payment can include billing the hospital directly.

An exemplary algorithm 280, FIG. 11, that can be used with algorithm program 32, FIG. 2, begins at block 282 with an identified symptom, which is polyuria. In block 284, a test is specified, which in this case is confirming the polyuria with a 24 hour urine collection. Test data is obtained in block 286 to check the urine Osm level of the collected urine. Depending on the level of Osm, the algorithm either proceeds to block 288, 290 or 292. For each of blocks 288, 290 and 292, the next block in the algorithm is to perform another test of checking the serum sodium at either block 294 or 296. Depending on the levels of serum sodium and Osm in the urine, the algorithm proceeds to block 298, 300, 302 or 304. If the level of serum sodium brought algorithm 280 to block 298, this would indicate in block 306 a diagnosis of primary polydipsia. If the level of serum sodium brought algorithm 280 to block 300, this would indicate in block 308 a diagnosis of diabetes insipidus. If the levels of serum sodium and Osm brought algorithm 280 to block 302, the next block in algorithm 280 is to measure in the urine the levels of NaCl, HCO₃ ketones. Depending on the level of these substances, algorithm 280 would proceed to either block 312, 314 or 316 which would lead to the specific diagnosis in the appropriate block at 318, 320 or 322. If the level of serum sodium brought the algorithm to block 304, the urine is measured for solutes such as glucose or urea. Depending on the level of these substances, algorithm 280 proceeds to either of blocks 324, 326 or 328 which would then lead algorithm 280 to the appropriate diagnosis in block 330, 332 or 334. The appropriate diagnosis obtained from algorithm 280 is presented to the user as either a provisional, differential or final diagnosis.

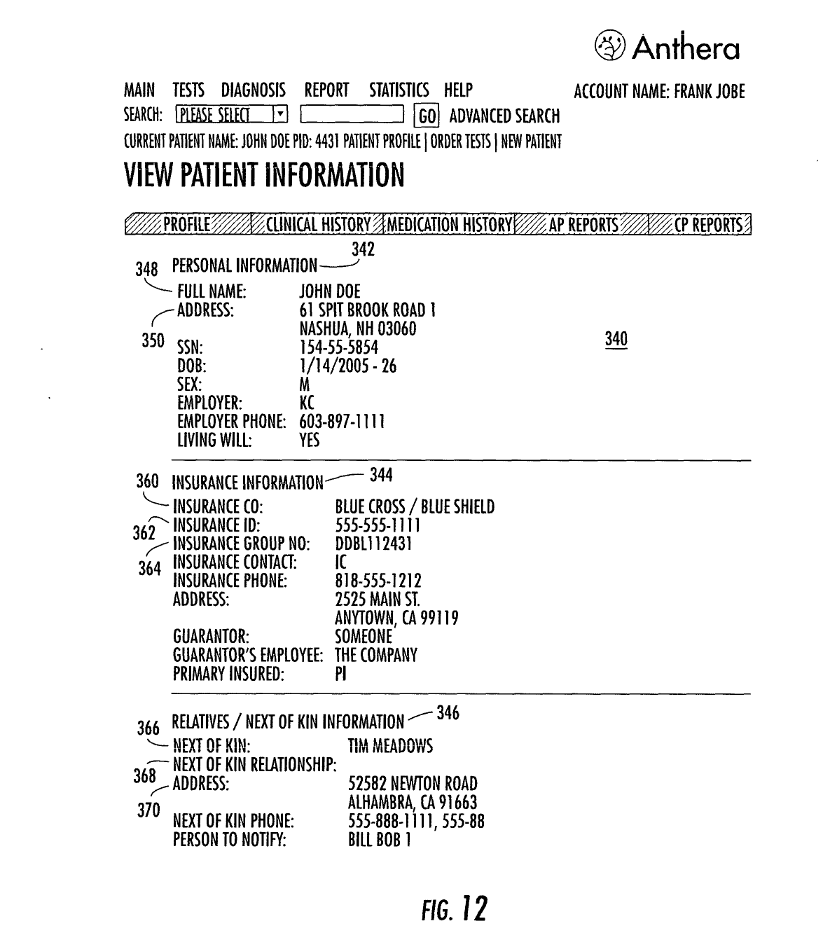

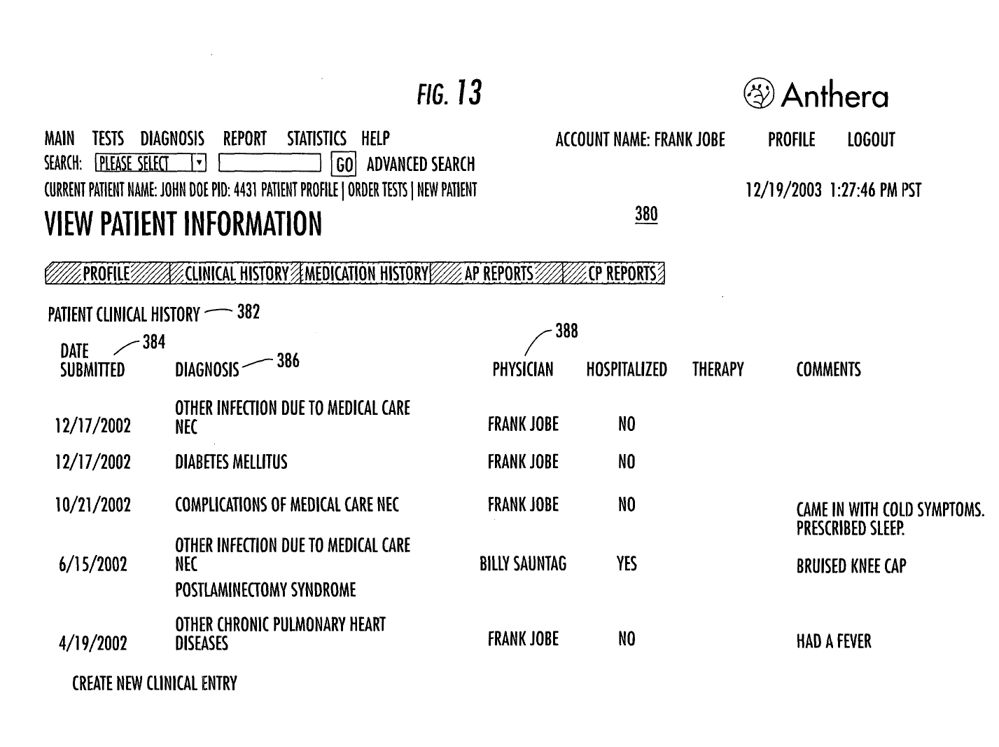

A patient profile software interface 340, FIG. 12, includes information such as personal information 342, insurance information 344, and relatives or next-of-kin information 346. Personal information 342 includes the patient name 348, the patient's address 350 and other personal information about the patient. Insurance information 344 includes the insurance company 360, the insurance identification 362, the insurance group number 364, and other relevant information about the patient's insurance coverage or provider. Relatives or next-of-kin information 346 can include the next of kin 366, the next-of-kin relationship 368, the next-of-kin address 370 and other information relating to the patient's relative or next of kin.

A patient clinical history software interface 380 displays patient clinical history 282 including the date of entry of the clinical history 384, the diagnosis 386, the physician 388 and other information relevant to the patient's clinical history. A user, such as a physician, can view this information to determine past clinical care that a specific patient has received.

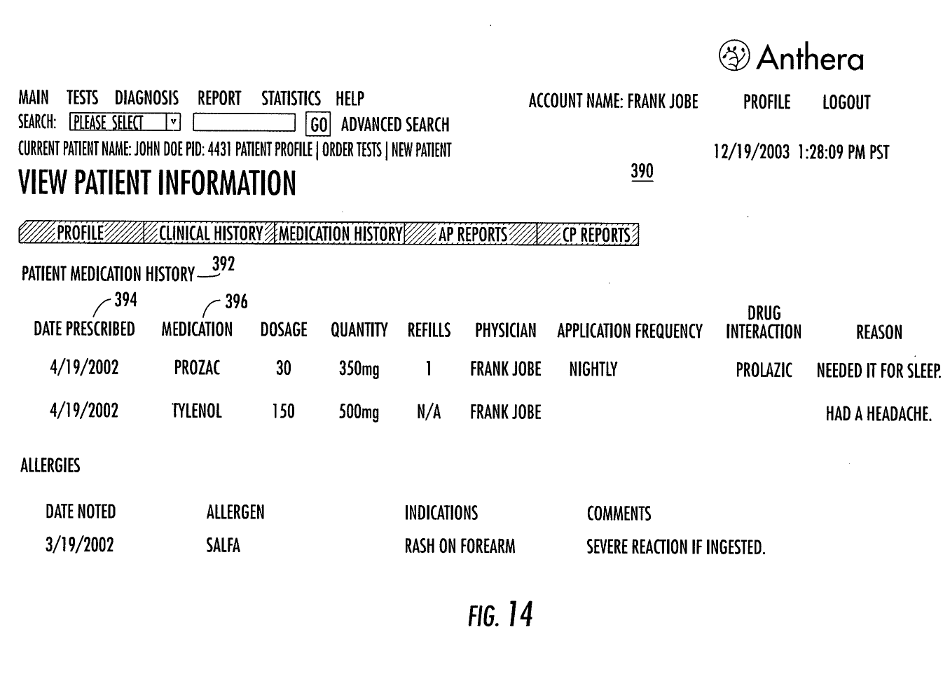

A patient medication history software interface 390, FIG. 14, displays patient medication history 392, which includes the date that medication was prescribed 394, medication prescribed 396 and other relevant information about the patient's medication history. A physician can view this information to determine what medications a patient had been or is currently taking.

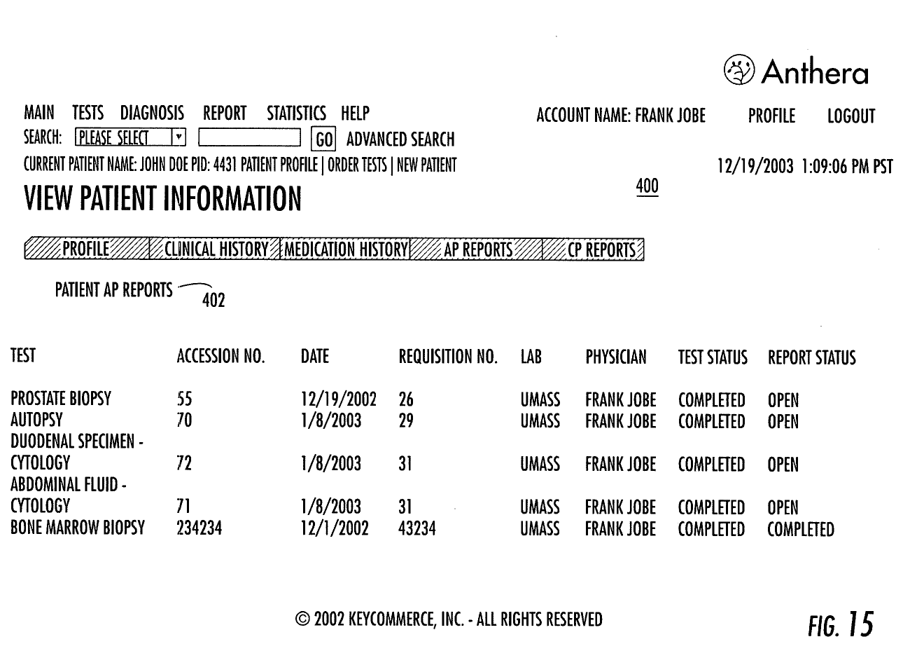

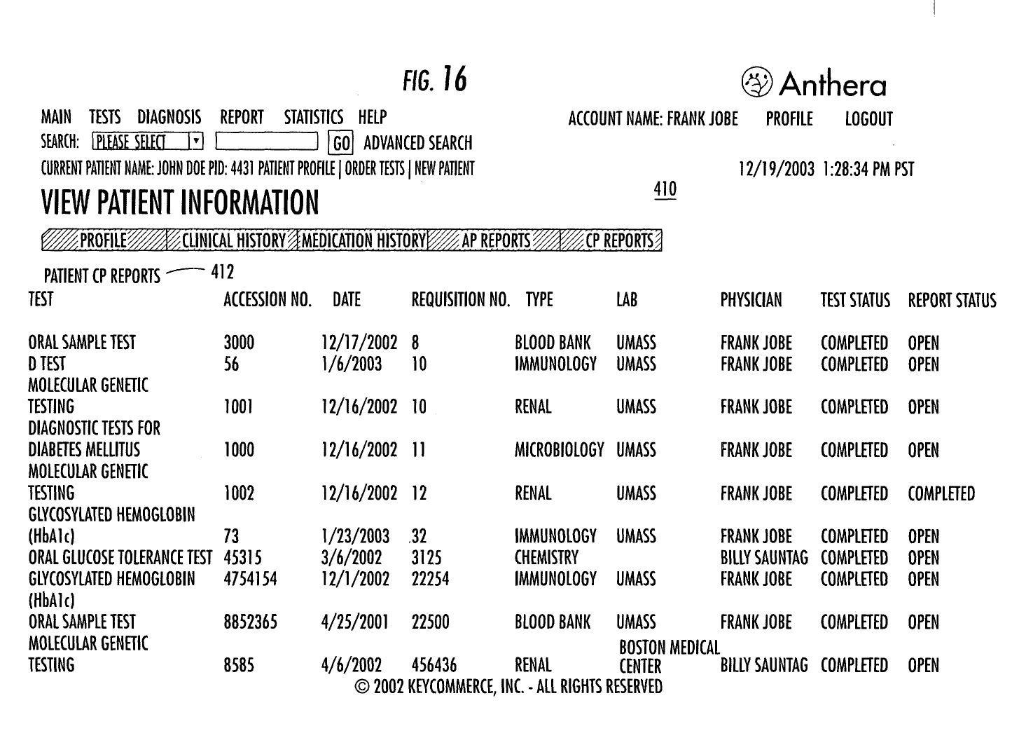

A patient anatomical pathology (AP) report software interface 400, FIG. 15, displays patient AP reports 402 and the relevant information about these reports. A clinical pathology (CP) report software interface 410, FIG. 16, displays patient CP reports 412 and the information related to the CP reports previously obtained.

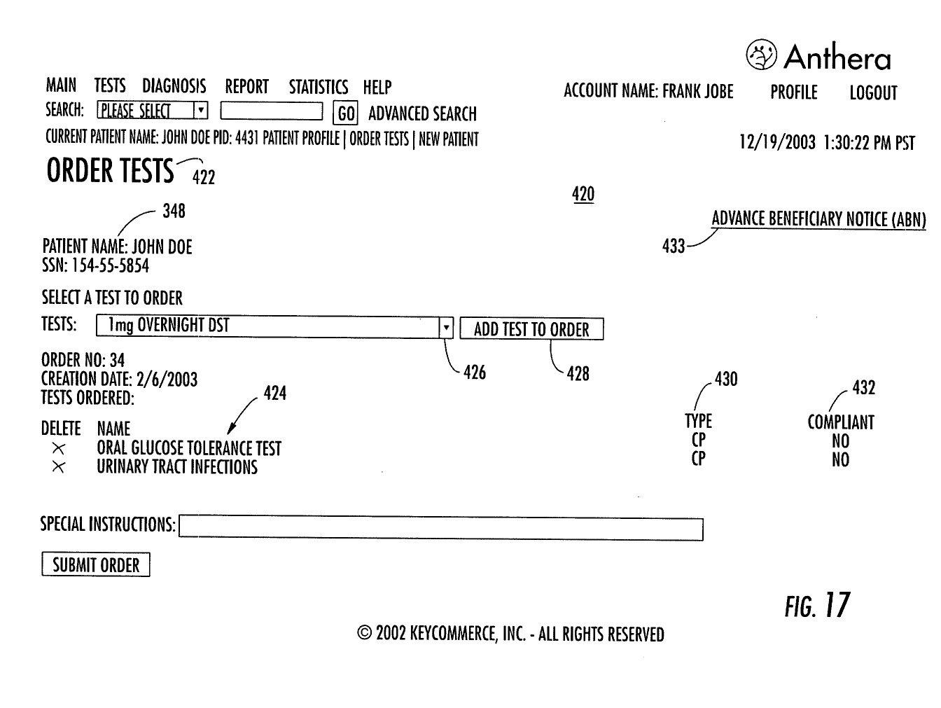

A test ordering software interface 420, FIG. 17, includes a mechanism for ordering one or more tests for a specific patient. Software interface 420 includes the patient's name 348 and the one or more tests 424 ordered for the patient. A user, such as a physician, orders an additional test by selecting button 426, scrolling to the desired test and clicking on the desired test, and selecting button 428 to add the tests to the order. Software interface 420 can include the type 430 of ordered test and whether or not each test is compliant or has constraints 432 against ordering the test. A link 433 is provided to allow a user, such as a patient, to obtain and execute an ABN form. The server can provide the ABN form link 433 to the user if one of the selected tests is designated as having a constraint as at 432.

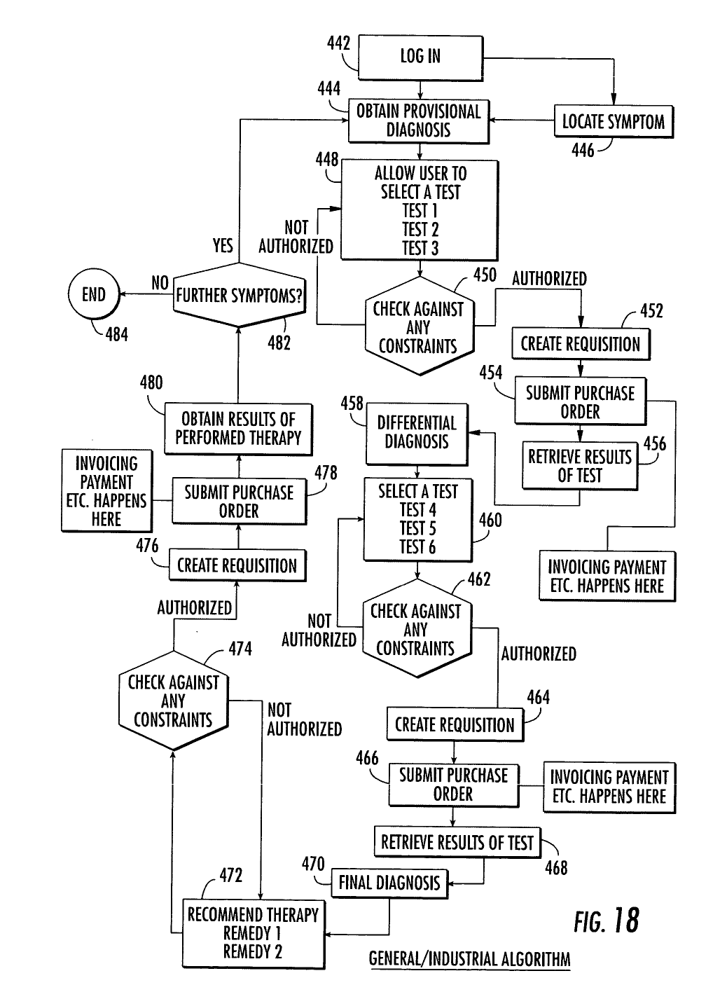

In yet another embodiment, the flowchart of FIG. 18 describes a general or industrial method and begins at step 442 with allowing a user to log in to server 12, FIG. 1, and obtaining a provisional diagnosis from the user in step 444, FIG. 18. The provisional diagnosis can be for any general, mechanical, or electrical problem or condition. The server can either provide the provisional diagnosis based on one or more symptoms given by the user in step 446 or can use an algorithm to provide a diagnosis based upon previously obtained data. In step 448, the server allows the user to select one or more tests. In step 450, the server determines whether there are any constraints against ordering the one or more tests ordered in step 448. If there are any constraints against ordering a test, the user is prompted again to select one or more tests. If there are no constraints against ordering the tests the server creates a requisition in step 452 and prepares a purchase order in step 454. The server obtains payment for the test in step 454. In step 456, the server retrieves the results of the tests. In step 458, the server uses one or more algorithms to determine a differential diagnosis based upon the test results. In step 460, the user is prompted whether or not the user would like to select an additional test. In step 462, the server determines whether there are any constraints against the one or more tests ordered in step 460. If no constraints exist on ordering the test, the server creates a requisition in step 464 and a purchase order in step 466. The server obtains payment for the test in step 466. Once the tests have been completed, the server obtains the results of the test in step 468 and determines a final diagnosis in step 470 using one or more algorithms.

The server recommends one or more therapies in step 472 based on the final diagnosis determined in step 470. In step 474, the server determines whether there are any constraints against obtaining the recommended therapy and allows the user to select another recommended therapy in step 472 if there are any constraints. In step 476, if the user is authorized to obtain the one or more selected therapies, the server creates a requisition in step 476, submits a purchase order and obtains payment in step 478. In step 480, the server obtains data about the performed therapy and determines in step 482 whether any further symptoms of the condition exist. If it is determined in step 482 that no further symptoms of the condition exist, then the method ends at step 484. If further symptoms of the condition exist then the user can begin the method again at step 444 by obtaining a provisional diagnosis and selecting one or more tests in step 448 to diagnose the condition.

The methods of the present invention can be performed with a server or computer and computer software installed thereon that has instructions to perform the steps of the invention. Alternatively, methods of the present invention can be performed with equipment that has installed hardware or firmware having instructions to perform the steps of the invention. Software used with embodiments of the present invention can be stored on computer readable medium for storing data, such as, for example, but not limited to, floppy disks, magnetic tape, zip disks, hard drives, CD-ROM, optical disks, RAM, ROM, PROM or a combination of these.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A method for ordering over a network one or more tests for a condition, the method comprising:
recommending to the user over the network one or more tests based on a provisional diagnosis of the condition;
providing to the user over the network an analysis of the one or more recommended tests if more than one test is recommended;
allowing a user to select over the network one or more of the tests;
determining whether a constraint exists on ordering any of the selected tests;
ordering each of the selected tests over the network if no constraint exists to obtain each of the selected tests; and
obtaining a result of each of the selected tests.

2. The method of claim 1 further including obtaining payment for a test when the test is ordered if the test is not covered by insurance.

3. The method of claim 1 further including providing one or more final diagnoses for the condition based on the result of each of the selected tests.

4. The method of claim 1 further including allowing a user to identify at least one symptom of the condition.

5. The method of claim 1 further including:
recommending over the network at least one treatment based on the test results to cure the identified condition;
identifying whether there is any constraint on ordering the recommended treatment; and
ordering the treatment if no constraint exists for user to obtain the treatment.

6. The method of claim 1 further including allowing the user to provide an override to order a test if a constraint exists on ordering the test.

7. The method of claim 6 further including providing a notification of the override to one or more parties.

8. The method of claim 1, wherein determining whether there are any constraints on the one or more tests comprises comparing an ICD 9 code for the provisional diagnosis with a CPT code for each of the selected tests to determine whether there is any constraint on each of the selected tests.

9. The method of claim 1, wherein providing to the user an analysis of the tests comprises providing to the user a cost analysis of each of the tests if more than one test is recommended.

10. The method of claim 1 further including:
collecting user feedback; and
modifying the one or more recommended tests based upon the user feedback.

11. The method of claim 1 further including:
collecting user feedback; and
modifying how to interpret the result of a selected test based upon the user feedback.

12. The method of claim 1 further including:
collecting user feedback; and
creating guidelines based upon the user feedback.

13. The method of claim 1, wherein the user is a physician.

14. The method of claim 1, further including obtaining a recognition from a patient that insurance will not pay for a test.

15. A method for ordering tests over a network for a condition, the method comprising:
recommending to the user over the network a plurality of tests based on a provisional diagnosis of the condition;
allowing a user to select over the network two or more of the recommended tests;
determining whether a constraint exists on ordering any of the selected tests;
ordering each of the selected tests over the network if no constraint exists for the user to obtain each of the tests;
routing over the network each of the selected tests to the corresponding supplier of each test; and
obtaining a result of each of the selected tests.

16. The method of claim 15 further including providing one or more final diagnoses for the condition based on the result of each of the selected tests.

17. The method of claim 15 further including obtaining payment for one of the tests if a constraint exists on ordering the test.

18. The method of claim 15 further including allowing the user to provide an override to order one of the tests if one of the tests is not covered by insurance.

19. A method for diagnosing over a network a condition and suggesting a treatment comprising:
allowing a user to identify over the network at least one symptom of a condition;
hypothesizing a provisional diagnosis of the condition;
recommending to the user over the network one or more tests based on the provisional diagnosis;
providing to the user over the network an analysis of the tests if more than one test is recommended;
allowing a user to select one of the tests;
determining whether there are any constraints on the selected test;
ordering the test over the network if no constraint exists for the user to obtain the selected test;
obtaining a result of the selected test;
identifying the problem based on the result of the selected test;
recommending over the network at least one treatment based on the test result to cure the identified condition;
identifying whether there are any constraints relating to the recommended treatment; and
ordering the treatment if no constraints exist for user to obtain the treatment.

20. The method of claim 19 further including providing a list of services or products from one or more suppliers relating to the recommended test.

21. The method of claim 19 further including providing a list of services or products from one or more suppliers relating to the recommended treatment.

22. The method of claim 19, wherein the method of claim 19 is repeated if the condition is unable to be identified based on the result of the test.

23. An article of manufacture, comprising:
a computer readable medium having computer readable program code for ordering over a network one or more tests for a condition, the computer readable program code including instructions for:
causing the computer system to obtain a provisional diagnosis of the condition;
causing the computer system to recommend to the user over the network one or more tests based on the provisional diagnosis;
causing the computer system to provide to the user over the network an analysis of the one or more recommended tests if more than one test is recommended;
causing the computer system to allow a user to select over the network one or more of the tests;
causing the computer system to determine whether a constraint exists on ordering any of the selected tests;
causing the computer system to order each of the selected tests over the network if no constraint exists to obtain each of the selected tests; and
causing the computer system to obtain a result of each of the selected tests.

24. The article of manufacture of claim 23, wherein the computer readable program code further comprises instructions for:
causing the computer system to obtain payment for a test if a constraint exists on ordering the test.

25. The article of manufacture of claim 23, wherein the computer readable program code further comprises instructions for causing the computer system to provide one or more final diagnoses for the condition based on the result of each of the selected tests.

26. The article of manufacture of claim 23, wherein the computer readable program code further comprises instructions for causing the computer system to allow a user to identify over the network at least one symptom of a condition.

27. The article of manufacture of claim 23, wherein the computer readable program code further comprises instructions for causing the computer system to allow the user to provide over the network an override to order the test if a constraint exists on ordering the test.

28. The article of manufacture of claim 27, wherein the computer readable program code further comprises instructions for causing the computer system to provide a notification of the override to one or more parties.

29. The article of manufacture of claim 23, wherein the computer readable program code further comprises instructions for:
causing the computer system to collect user feedback; and
causing the computer system to modify the recommended tests based upon the user feedback.

30. A server comprising:
a computer including a processor and computer readable program code executable on the processor for ordering over a network one or more tests for a condition, the computer readable program code configured to:
recommend to the user over the network one or more tests based on a provisional diagnosis of the condition;
provide to the user over the network an analysis of the one or more recommended tests if more than one test is recommended;
allow a user to select over the network one or more of the tests;
determine whether a constraint exists on ordering any of the selected tests;
order over the network each of the selected tests if no constraint exists to obtain each of the selected tests; and
obtain a result of each of the selected tests.

31. The server of claim 30, wherein the computer readable program code is further configured to obtain payment for a test if a constraint exists on ordering the test.

32. The server of claim 30, wherein the computer readable program code is further configured to provide one or more final diagnoses for the condition based on the result of each of the selected tests.

33. The server of claim 30, wherein the computer readable program code is further configured to allow a user to identify at least one symptom of a condition.

34. The server of claim 30, wherein the computer readable program code is further configured to allow the user to provide an override to order a test if a constraint exists on ordering the test.

35. The server of claim 30, wherein the computer readable program code is further configured to provide a notification of the override to one or more parties.

36. The server of claim 30, wherein the computer readable program code is further configured to:
collect user feedback; and
modify the recommended tests based upon the user feedback.
